(19) United States
(12) Patent Application Publication
(10) Pub. No.: US 2008/0249925 A1
(43) Pub. Date: Oct. 9, 2008

(54) LIABILITY ADVICE SYSTEM AND METHOD

(75) Inventors: Amir A. NAZARI, Los Altos, CA (US); Pejman MAKHFI, San Jose, CA (US); Kenneth J. SINGLETON, Portola Valley, CA (US); Jonathan R. PEDLEY, Redwood City, CA (US)

Correspondence Address: WILMERHALE/BOSTON, 60 STATE STREET, BOSTON, MA, 02109, US

(73) Assignee: FINANCIAL CROSSING, INC., Palo Alto, CA (US)

(21) Appl. No.: 11/955,618

(22) Filed: Dec. 13, 2007

Related U.S. Application Data
(60) Provisional application No. 60/921,737, filed on Apr. 4, 2007.

(51) Int. Cl. G06Q 40/00

(52) U.S. Cl. 705/38; 705/35

(57) ABSTRACT

A computerized method and apparatus for providing a borrower with a choice of products relating to new debts or changes to a portfolio of debts. The method can include collecting borrower information using a user interface, building scenarios of debt products currently available to the borrower, evaluating the scenarios of debt products using (i) payment models for the scenarios determined based on interest and loan information and (ii) the borrower information, and selecting one or more of the scenarios based on the evaluation of the scenarios.

### CROSS REFERENCE TO RELATED APPLICATIONS

This application claims benefit of U.S. Provisional Patent Application Ser. No. 60/921,737, filed on Apr. 4, 2007.

### BACKGROUND OF THE INVENTION

For many years, affluent individuals have had access to a wide range of options for their investments covering asset allocation, security selection, and planning for long-term financial goals. An appropriately equipped financial advisor can help investors navigate the enormous range of possible investments available to them and ensure that the portfolios they select are well aligned with their financial goals, their willingness and ability to tolerate risk, and their time horizon. In addition, there are rigorous regulations that help ensure that a client is provided with all the necessary information they need to make the choices that are right for them.

The same is not true in the consumer lending and mortgage industries. There has been a recent explosion in product innovation (including interest-only loans and so-called negative amortization loans or “Option Arms”) and in the number of providers of mortgage products, making the choices facing a borrower as complex as those faced on the investment side. In addition, there is a lack of adequate tools to enable a financial professional and a borrower to ensure that a proposed loan, or a portfolio of liabilities, are a good match to the borrower's needs (i.e. that the loan is suitable for the borrower) and that the borrower understands the relative risks and benefits of the loan or loans. Further, there is no mechanism for comparing all the possible products from all possible lenders.

### BRIEF SUMMARY OF THE INVENTION

One embodiment of the invention is a computerized method for providing a borrower with a choice of products relating to new debts or changes to a portfolio of debts. According to this embodiment, the method includes collecting borrower information using a user interface, building scenarios of debt products currently available to the borrower; evaluating the scenarios of debt products using (i) payment models for the scenarios determined based on interest and/or loan information and (ii) the borrower information, and selecting one or more of the scenarios based on the evaluation of the scenarios.

Another embodiment of the invention is also a computerized method for providing a borrower with a choice of products relating to new debts or changes to an existing portfolio of debts. According to this aspect, the method includes collecting borrower information using a user interface, generating possible scenarios of existing debt products for the borrower, retaining scenarios of existing debt products currently available to the borrower based on the borrower information and determinations of borrower eligibility and pricing information for the existing debt products, building payment models for the scenarios using models based on interest rate and/or loan information, evaluating the payment models using the borrower information, and selecting one or more of the scenarios based on the evaluation of payment models.

Yet another embodiment of the invention is an apparatus for providing a borrower with a choice of products relating to new debts or changes to an existing portfolio of debts. According to this aspect, the apparatus includes a user interface module to collect borrower information, a scenario generation module to generate possible scenarios of existing debt products for the borrower, a quotation engine to retain scenarios of existing debt products currently available to the borrower based on the borrower information and determinations of borrower eligibility and pricing information for the existing debt products, and a scenario selection module. The scenario selection module can build payment models for the scenarios using models based on interest rate and/or loan information, evaluate the payment models using the borrower information, and select one or more of the scenarios based on the evaluation of payment models.

Another embodiment of the invention is a system enabling a finance professional to recommend a new mortgage or other liability or to recommend changes to a portfolio of liabilities that are aligned with a borrower's financial goals, ability to tolerate adverse payment fluctuations in the future, and time horizon. The system takes into account needs of a borrower and any existing portfolio of liabilities and plans for a new portfolio of liabilities that improve on the borrower's situation with regard to some combination of: near-term cash flow; projected long-term net worth; ability and willingness to tolerate adverse payment fluctuations; and time horizon. Recommendations can be executed through a lender or lenders' loan origination systems. The system also can include an advanced analytics system for modeling the distribution of future liability service payments and evaluating potential restructuring scenarios according to that model and to the borrower's financial circumstances.

Another embodiment of the invention is a computerized liability advice system and method. The computerized liability advice system and method equips the financial professional with the tools and infrastructure needed to be able to provide advice to individuals on their liabilities. In general, the method and system enable a financial professional to recommend a new liability or portfolio of liabilities, or to propose a restructuring of an existing portfolio of liabilities, from a full list of liability options available to an individual through the financial professional and then to execute on the recommendations, once accepted. The recommendations can be developed considering: the client's individual financial circumstances and goals, up-to-date comprehensive underwriting guidelines and pricing for a broad range of loans and other lending products (including, but not limited to real-estate secured loans and lines of credit; margin loans, pledged-asset mortgages and other loans secured by investment securities; credit cards; auto loans, student loans and all other consumer loans; small-business loans), and models for the distribution of interest-rate indices and corresponding debt-service payments on the current and proposed liabilities. Current and proposed liabilities analyzed and recommended can include any liability from the preceding list that is available to the individual through the financial professional with whom he/she is discussing his/her liabilities.

According to one aspect, an embodiment of the invention involves obtaining information on the client, their financial circumstances, their existing portfolio of liabilities and their financial goals, circumstances and needs, developing a series of scenarios to meet that need (e.g., a new home or asset purchase, the restructuring of an existing portfolio of liabilities, funds to meet a pressing family circumstance) and then evaluating those scenarios to deliver a proposal to the client of the subset of scenarios best addressing the client needs, subsequently executing on the new liabilities or lending products required to implement the proposal should the client agree. Once information on the client's liability portfolio is captured, a financial professional can monitor it, taking into account changes in factors affecting liability choices, including the pricing and availability of lending products, changes in the interest rate environment, changes in the client's circumstances, economic factors, and tax laws. The system and method of the invention can monitor these changes and indicate that a restructuring may be beneficial.

According to one aspect, the invention is a computer-implemented method for providing a borrower with a choice of new lending products and/or changes to an existing portfolio of debts that are most likely to meet the needs, constraints and goals of the borrower. According to this aspect, the invention includes consideration of some or all of the following information: (1) the period of time over which the borrower wishes to optimize her wealth or cash flow (time horizon); (2) the borrower's willingness and ability to tolerate volatility or expected future increases in mortgage payments in exchange for improved expected wealth or payments (mortgage risk tolerance); (3) the constraints the borrower or the lending institution(s) wishes to impose on the menu of products from which to make a selection; (4) any constraints the borrower wishes to impose on monthly debt service payments; (5) the value, expected returns and cost basis of the borrower's portfolio of investment securities; (6) expected returns on the borrower's investment in real property; (7) the estimated and appraised values of the borrower's real property; (8) the type and planned usage of the borrower's real property; (9) the total level of indebtedness of the borrower; (10) the credit-worthiness of the borrower as measured by FICO, Vantage scores or other methods as they are developed; (11) the borrower's needs and goals—particularly relating to cashflow constraints; the importance of near-term cash flow savings vs. long-term wealth improvement; and the importance of improving the borrower's credit score; and (12) other attributes of the borrower, the borrower's assets, and the borrower's liabilities that are conventionally used to make lending decisions.

According to some embodiments, a method according to the invention includes obtaining information on the borrower, the borrower's financial situation, the borrower's assets and liabilities, and the borrower's goals, needs, and preferences as constraints on borrowing. This information can be obtained by soliciting the borrower and capturing responses directly or indirectly using a computer-implemented user interface including at least one input device and one output device. This information can also be obtained by electronic feed from other systems, including Client Relationship Management (CRM) systems, Automated Valuation Model (AVM) systems, the systems belonging to Credit Rating Agencies, loan origination and underwriting systems, and other systems used to store data on the borrower and her financial situation. In this embodiment, the invention can also include determining the range of possible scenarios in which the client's current and desired level of indebtedness can be achieved using the full range of lending products available from one or more lenders. In addition, this embodiment can also include, for each scenario, determining if the borrower is eligible to enter into that scenario based on the borrower information captured and the lending guidelines of any lender offering the product or product(s) employed in the scenario. Some embodiments of the invention can also include, for every eligible scenario, determining the financial characteristics of each lending product making up the scenario and the best pricing available on each product from each lender offering the product using up-to-date feeds of product pricing and other information from the chosen lender(s). Such embodiments can also include building statistical models of the future levels of all interest rate indexes used to determine future payments on each lending product and deriving statistical models for the future levels of payments on each lending product in the scenario.

The embodiment of the invention described above can also include using information about the client (mortgage risk tolerance/risk aversion, time horizon, preferences such as a desire for short-term low debt service payments versus long-term wealth improvement, and constraints), the detailed characteristics of each lending product, including but not limited to underlying index, margin, rate, discount points, cap structure, and amortization schedule, and models for the relevant mortgage indices to select a number of scenarios that best trade off expected outcome versus risk based on the data captured on the client. The invention can also include displaying the impact of implementing each selected scenario both against the effect of doing nothing and leaving the existing liability portfolio in place and against the effect of implementing the other chosen scenarios, as well as displaying customized descriptions of what is envisioned by each chosen scenario and of each of the new lending products recommended for implementation in each scenario.

In some embodiments of the invention, rules are used to generate a finite range of scenarios that might offer a benefit to the client, rather than the near-infinite range of possible hypothetical scenarios. In addition, in some embodiments, the borrower's portfolio can be monitored periodically, such as daily, to determine the potential financial impact of each day's best scenarios, and these scenarios can be displayed to the advisor and/or the client via both electronic and physical (e.g., paper) means.

According to another embodiment many of the aspects of the invention set forth above and the information gathered from and about the borrower or the borrower's liabilities can be used to generate a so-called “liability health check,” which is a high-level overview of the borrower's current debt situation that can be used to understand the answers to questions such as, but not limited to: (1) whether there are other lending products available at superior pricing and terms to any existing loan; (2) whether there are other lending products or collections of products that might be more suitable to the client's needs, preferences and financial circumstances; (3) whether debt service payments can be reduced; (4) whether there is an opportunity to improve the borrower's creditworthiness; and (5) whether the client's home equity can be used for beneficial investment purposes.

According to other embodiments of the invention, the methods described above may be wholly or partially made accessible directly to the borrower without the intervention of a professional via the internet or other communication mechanism.

According to other embodiments of the system, the method can provide advice, following the same principles described above and in more detail below, regarding the liabilities of other borrowers aside from individuals and private consumers/borrowers. In addition, the borrower can include a small business, a not-for-profit institution, a corporation, or any debt-bearing organization. The invention can use a similar approach for each of these types of borrowers—it is only the details of the available debt products and the tax and regulatory considerations regarding their use that change.

### BRIEF DESCRIPTION OF THE DRAWINGS

FIG. 1 is a schematic diagram of a system constructed and arranged in accordance with an embodiment of the present invention.

FIG. 2 is a high-level flow chart of steps followed by the financial professional when working with a client to provide liability advice according to one embodiment of the invention;

FIGS. 3A-3D are exemplary user interface displays illustrating examples of the client data capture process;

FIG. 4 is a high-level flow chart depicting the steps used to generate plans when a client wishes to generate funds for a specified purpose through a new liability or liabilities or to improve an existing liability portfolio;

FIG. 5 is a flow chart depicting the logic for generating potential liability scenarios depending on the value of a property and the proposed level of debt in relation to the property's value;

FIG. 6 is a flow chart depicting the logic for choosing which other liabilities in an existing liability portfolio should be prioritized for consideration for consolidation;

FIG. 7 is a portion of an exemplary user interface illustrating how a liability plan might be displayed to a financial professional;

FIGS. 8A-8E illustrate some exemplary portions of a user interface illustrating the additional graphs which might be included in a liability plan for clarity;

FIG. 9 is a portion of an exemplary user interface illustrating how a high level summary of the merits of a client's portfolio of liabilities can be displayed to the client or a liability professional; and

FIG. 10 is a portion of an exemplary user interface illustrating how the potential benefits of changing the liabilities of a number of borrowers can be displayed to a financial professional.

### DETAILED DESCRIPTION OF THE INVENTION

In the mortgage market today, little advice is available to an individual to assure her that the liabilities she has undertaken or plans to undertake in order to fund life events such as college funding, home or auto purchase, or credit card debt, are aligned with her financial circumstances, needs, and goals. There is also little available to help the individual understand the nature of those liabilities and their relative risks and benefits in more than a superficial way. There are frequently circumstances in which a different liability structure or the selection of a particular funding vehicle can bring the individual closer to meeting her financial goals and preferences. These preferences can include, for example, reducing monthly debt-service payments, improving long-term net worth, or reducing risk arising from fluctuating debt service payments. An individual can also have other goals and preferences. However, such insight is typically unavailable to the individual. Instead, the individual must make decisions based on little if any product knowledge of a range of debt products that vary widely in cost, payment profile, progress toward repayment, and the risk of future payment increases, from an enormous range of potential lenders, supported by frequently-confusing product advertising. If the potential borrower approaches a financial professional, the professional is equally ill-equipped to help the potential borrower and the professional's advice is typically limited to providing reasonably accurate pricing options.

The method and system according to the present invention avoids the weaknesses associated with the current mortgage and consumer lending industries by enabling the financial professional to recommend an approach to funding a financial need or to restructuring an existing portfolio of liabilities that comes closest to meeting the borrower's needs, goals and circumstances and to help the borrower to understand the nature and relative risks and benefits of the current liabilities and the proposed approach, while providing the professional with the necessary tools, explanations, and descriptions needed to credibly deliver advice.

To ease understanding, the discussion herein will focus specifically on the choice of real estate secured loans (such as mortgages and lines-of-credit) and of using such loans to restructure portfolios of liabilities. However, it should be understood that the present invention is not limited to mortgage loans, but instead encompasses all debt that can be undertaken by a private individual, a small business owner, or a corporate entity such as a company or non-profit organization. Such debt can include, but is not limited to, margin debt, pledged-asset mortgages and other liabilities secured by investment assets, credit card debt, college loans, auto and RV loans, boat loans, and business loans.

The system and process according to the present invention can be implemented using a combination of automated interfaces and manual processes. It should be appreciated, however, that a greater use of automated processing and a wider range of product features with multiple executions and elections are also contemplated by the present invention. This description provides for an implementation in which a financial professional captures client data and creates proposals on behalf of the client. However, execution of this system and process can also be used by a consumer over the Internet to capture her own information, view proposals, and apply for lending products without the involvement of a financial professional.

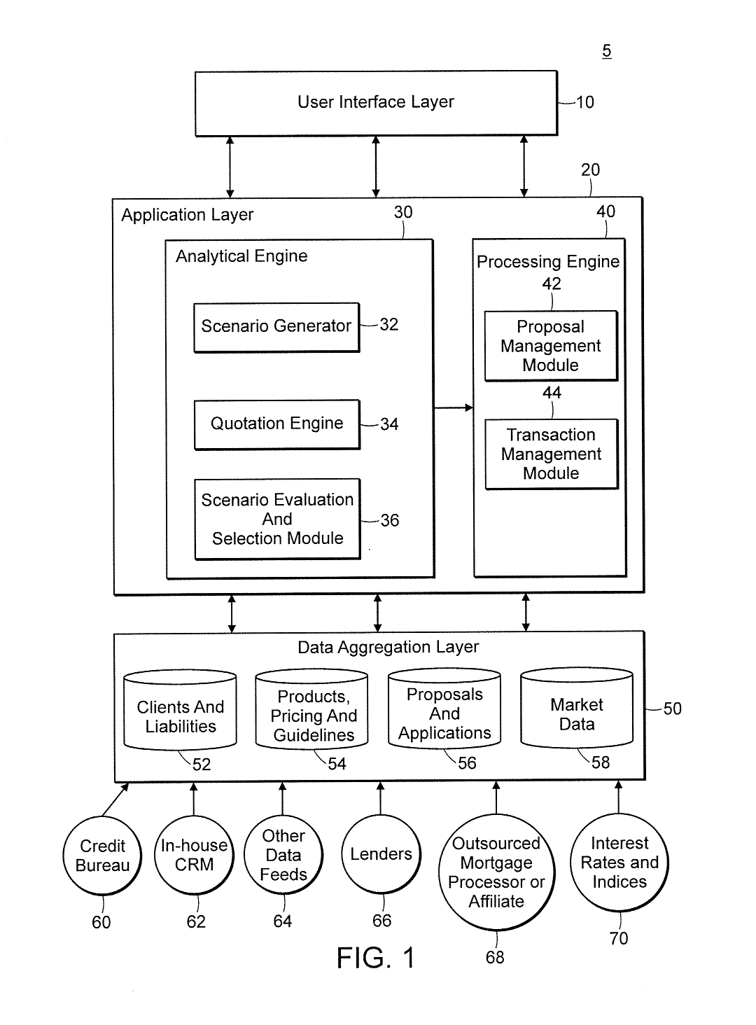

FIG. 1 is a schematic diagram of a system 5 constructed and arranged in accordance with one embodiment of the present invention. As shown in FIG. 1, the system 5 can include a user interface layer 10, an application layer 20, and a data aggregation layer 50. The user interface layer 10 can be a front end for a financial advisor that allows the advisor to access the system and method. In this embodiment, the advisor front end can be separated from business logic and can readily be customized to conform to the standards of an advisor. In another embodiment, the user interface layer 10 can be an Internet-based layer that allows a user, such as a financial advisor, to access and interact with the system 5 to enter information and receive screens from a Web-based server.

The application layer 20 includes an analytical engine 30 and a processing engine 40 in the embodiment of FIG. 1. In this embodiment, the application layer 20 can receive borrower information from the user interface layer 10 and data from the data aggregation layer 50, and use this information to generate and select scenarios of debt products for a borrower. The analytical engine 30 includes a scenario generator 32, a quotation engine 34, and a scenario evaluation and selection module 36. These modules of the analytical engine 30 perform tasks such as pre-analysis scenario generation, pricing and availability scanning, and post-analysis scenario evaluation. The scenario generator 32 can generate scenarios of debt products for further consideration by the other modules as set forth in greater detail below. The quotation engine 34 can perform further processing on the scenarios to reduce the number for consideration for the client. The scenario evaluation and selection module 36 can determine which of the scenarios are best for the client for presentation to the client. The processing engine 40 can be used for proposal management and transaction management. A proposal management module 42 of the processing engine 40 can be used to present scenarios to the user interface layer 10 so that the user can view proposed scenarios. A transaction management module 44 of the processing engine 40 can be used to pre-fill applications for debt products using borrower information, submit these applications, and then receive updates regarding these applications. The processing engine 40 can also include logic to monitor liability portfolios, lenders' available loans, eligibility standards, and pricing, client information and/or market data so that the potential benefits from restructuring clients' liabilities can be measured and presented to the client or to financial professionals via the Internet, email, or paper. This logic can cause the analytical engine 30 to perform its functions on a periodic basis in order to monitor proposed changes to new or existing portfolios of liabilities.

The data aggregation layer 50 can be databases, both internal and external to the system 5, that provide information about clients, liabilities, proposals, and market data. For example, in the embodiment of FIG. 1, the data aggregation layer 50 includes a clients and liabilities database 52, a products, pricing, and guidelines database 54, a proposals and applications database 56, and a market data database 58. These databases can be fed by a variety of sources, including the application layer 20 and third-party or other outside sources, such as credit bureaus 60, an in-house CRM system 62, other data feeds 64, lenders 66, outsourced mortgage processors or affiliates 68, and interest rate and index feeds 70.

The system 5 of FIG. 1 can implement the features set forth in greater detail below. Some embodiments of the invention described herein can be implemented, at least in part, using software-controlled programmable processing devices, such as a computer system. One or more computer programs for configuring such programmable devices or systems of devices to implement the described methods are to be considered an aspect of the present invention. For example, the user interface layer 10, application layer 20, and data aggregation layer 50 can interact to implement in software and computers the features set forth below.

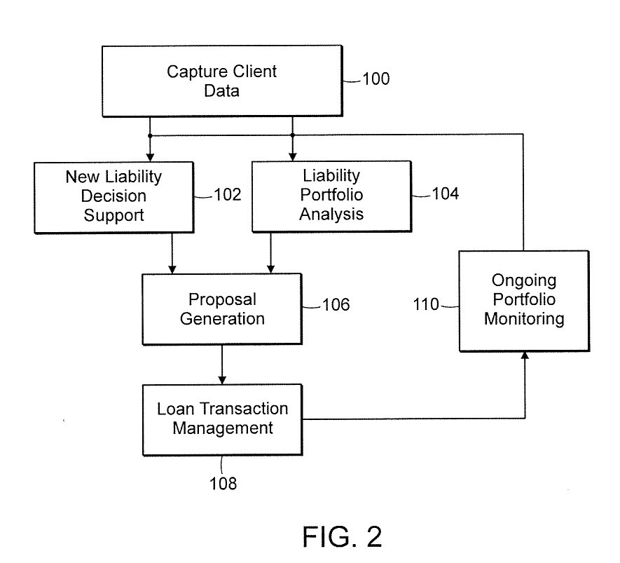

FIG. 2 depicts a high-level flow chart of the steps involved in providing and implementing liability advice and then monitoring a portfolio of liabilities according to an embodiment of the invention. As shown in FIG. 1, the invention can include capturing client data (step 100), performing new liability decision support (step 102) or liability portfolio analysis (step 104), generating a proposal for the borrower (step 106), performing loan transaction management such as applying for specific liability products (step 108), and performing ongoing portfolio monitoring periodically to capture up-to-date information about a portfolio of liabilities (step 110). Step 100 of capturing client data can be performed using the user interface layer 10 of FIG. 1. Steps 102, 104, and 106 can be performed in the application layer 20 of FIG. 1, and steps 108 and 110 of FIG. 2 can be performed using the user interface layer 10 and application layer 20 of FIG. 1.

This discussion will use the situation in which a financial professional works with the client to provide the client with liability advice, using software provided to the professional over the Internet. Alternative embodiments of the invention such as the software being made available to the financial professional via software resident on his own computer workstation or being made available directly to the client without the involvement of a financial professional are among the other embodiments of the invention.

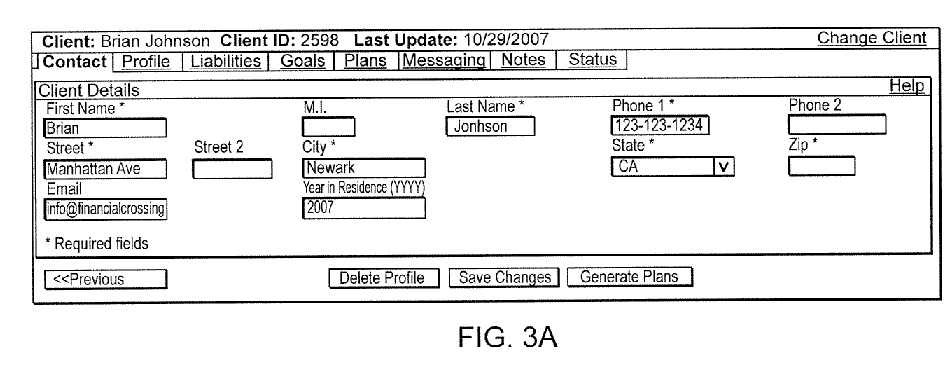

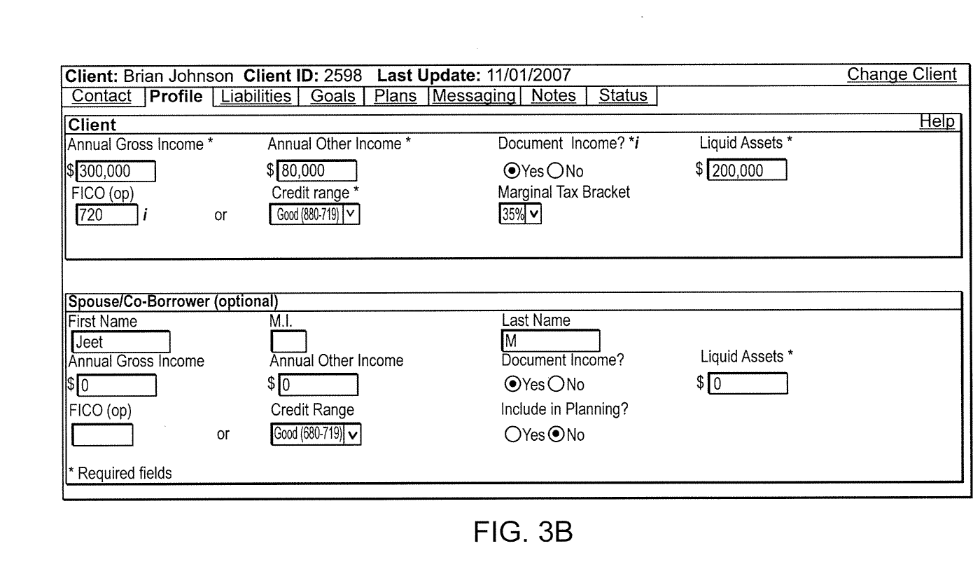

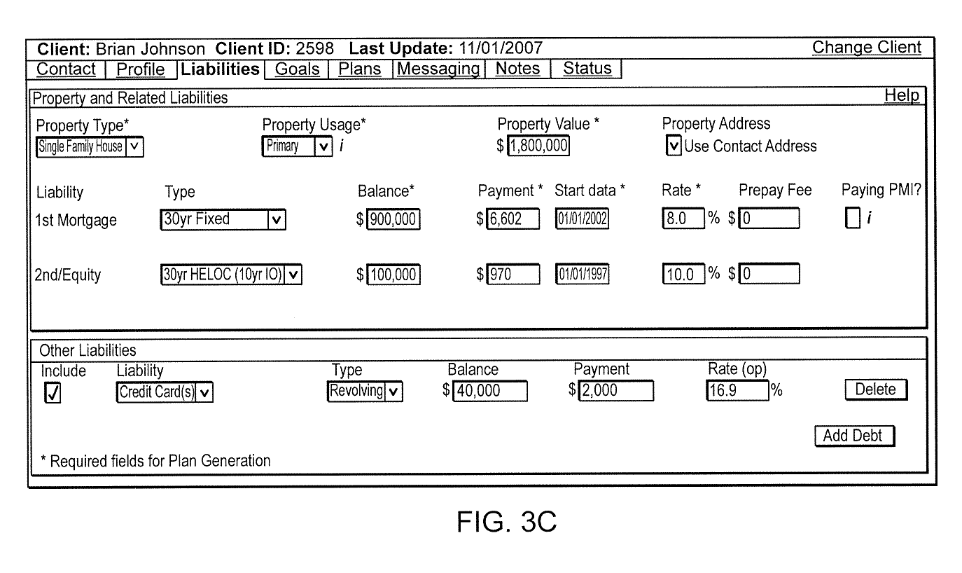

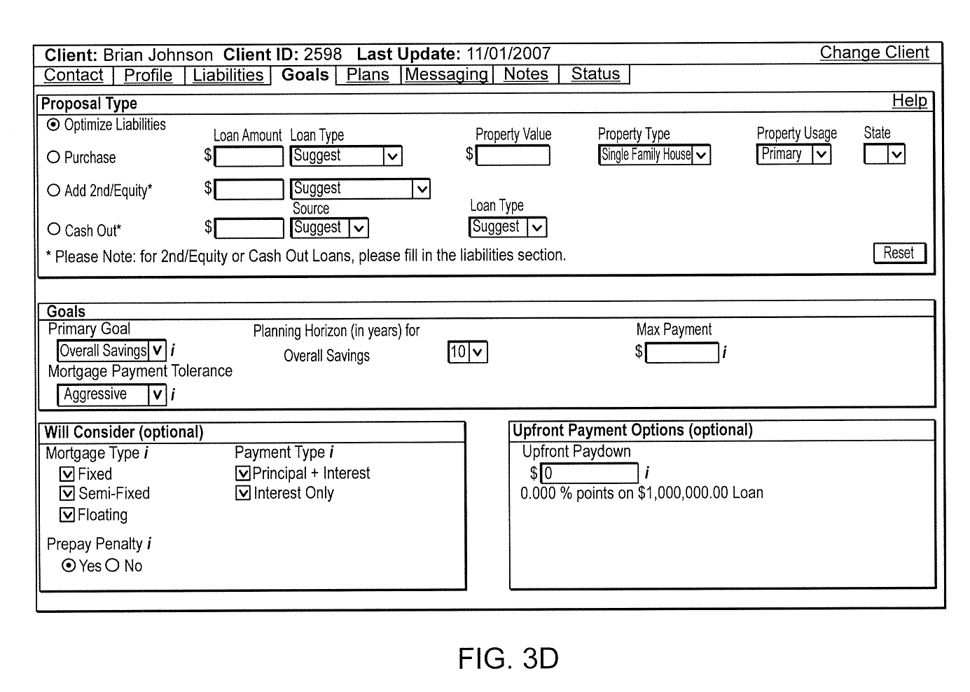

In step 100 of FIG. 2 the professional asks the client a series of questions and captures the answers to these questions using a user interface, such as the user interface screens shown in FIGS. 3A-3D. As shown in FIGS. 3A-3D, questions may cover basic contact information and information on the place of residence (FIG. 3A); high level financial information used to determine which lending products are available to the client from applicable lenders, the pricing of those products, and information on a client's investment assets and expected return on those assets (FIG. 3B); information on the client's existing liabilities—both real-estate-secured and non-sufficient to build distributions of potential future liability service payments to be made by the client (FIG. 3C); information about the client's objectives, such as to optimize an existing liability portfolio, take on a new liability, refinance a specific existing loan, or improve the borrower's credit rating, and goals, such as to minimize debt-service payments over a particular time horizon, or maximize risk-adjusted net worth or wealth over a specified time horizon (FIG. 3D); willingness and ability to handle future fluctuation in liability payments; the universe of products from which the client is willing to select; the desire to pay for the costs of any transaction by adding to the principal amount of the intended loan; and the availability of liquid cash, beyond any proposed down payment, to cover closing costs and potentially purchase a lower interest rate on a new loan.

Returning to FIG. 2, once the information is captured and a new plan requested by the financial professional, the system enters step 102 or 104 depending on whether the client wishes to take on a specific dollar amount of new liabilities (step 102) or optimize an existing liability portfolio (step 104). A hybrid approach by which the client simultaneously takes on new debt and optimizes an existing portfolio is also envisioned.

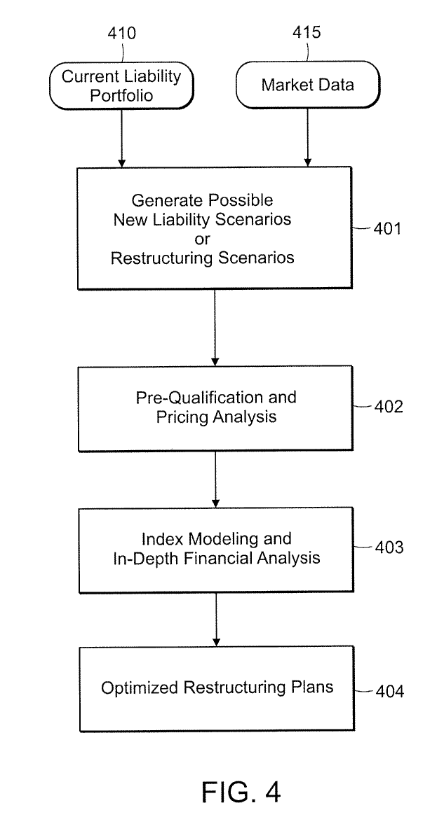

FIG. 4 is a high-level flow chart for step 102/104 of FIG. 2. FIG. 4 contains steps 401-404, which the following discussion describes in detail. Referring again to FIG. 2, step 102 involves seeking new debt products whereas step 104 involves optimizing an existing portfolio of debt products. Step 401 of FIG. 4 covers either scenario—generating scenarios for new liabilities or restructuring an existing portfolio.

### Step 401 of FIG. 4: Pre-Analysis

Returning again to FIG. 4, in step 401, the system and method of the invention consider the existing loan portfolio and build potential restructuring scenarios based on rules that represent best practices from the lending industry. This step can include (in the case of restructuring scenarios) all possible combinations of consolidation and/or refinancing using available products. In the case of restructuring scenarios, the inputs can include market data 415 and the current liability portfolio 410. This step may also involve (in the case of new liability scenarios) all possible mechanisms for funding new liabilities, considering products, ratios of first and second down payments, and vehicles for generating down payments. In the case of new liability scenarios, the input can include market data 415. The best practices of the industry, subject to a number of constraints, may include:
Loans secured by a client's property or properties should not be for more than a preset percentage of the property's value (the Loan-To-Value ratio or LTV<=a set %, such as 100% or 90%);
The client's overall indebtedness should not increase by more than the total closing costs for the proposed transaction(s) and even then only if the client requests it.
Consolidation of debt should not occur when it is practically not appropriate (for example, it is not wise to consolidate a small loan with only one payment outstanding);
If a loan on which Private Mortgage Insurance (PMI) is applicable is proposed, the effect of PMI should be considered (for example, if the LTV for the loan is greater than 80%);
Other rules and constraints which would be in accordance with industry best practices and regulatory demands can also be used.

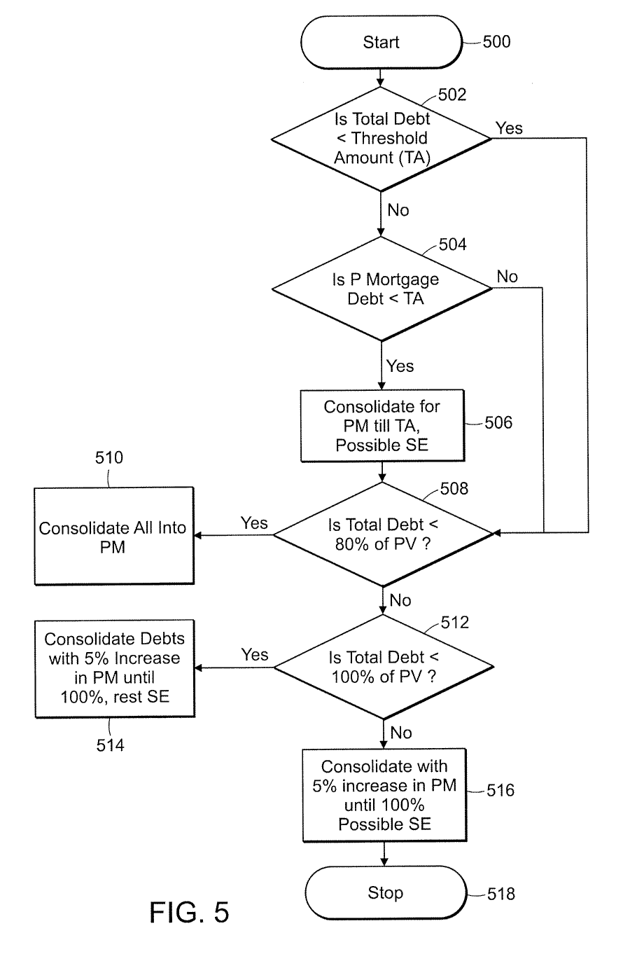

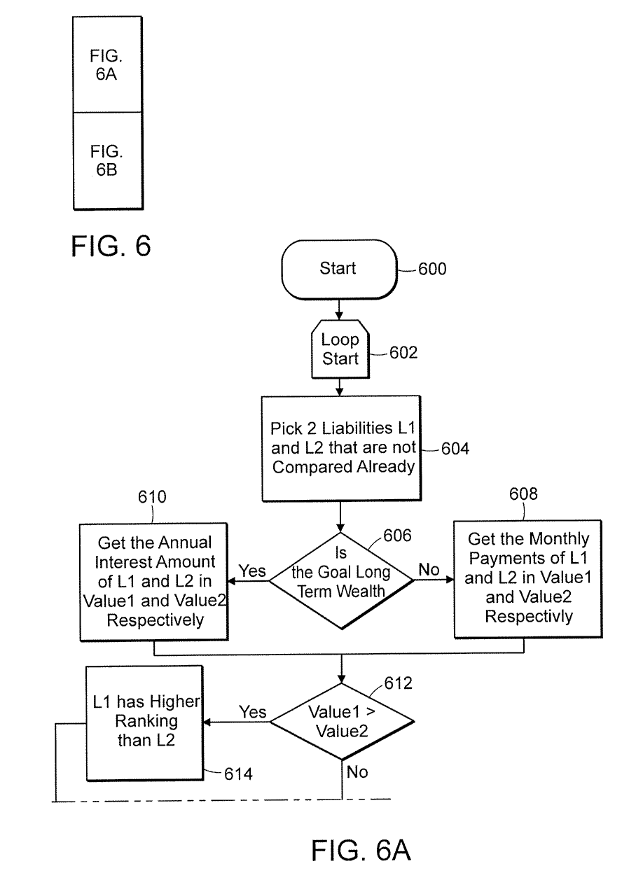

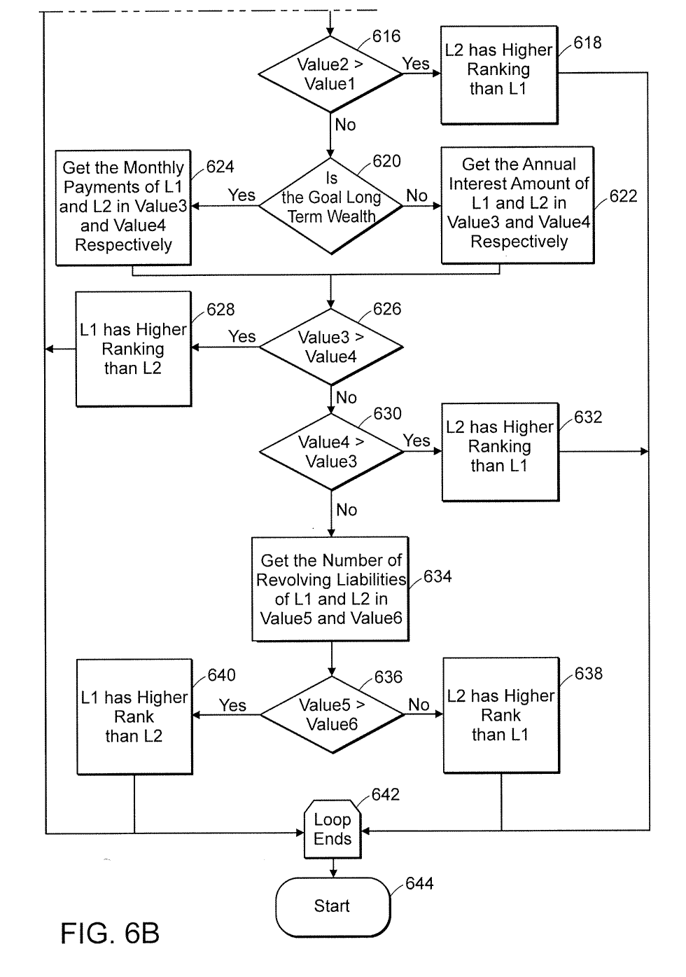

The full range of potential scenarios for new liability portfolio structures is then generated, including at a minimum:
Scenarios in which each individual mortgage/equity loan is simply refinanced using each of the products available to the client through the financial professional;
Scenarios in which a non-real estate secured debt, or combination of debts is consolidated wholly or partially with all or part of the existing real-estate-secured loans into new real-estate secured loans;
Scenarios in which an existing home equity loan/second mortgage (HEL) or Home equity line of credit (HELOC) is wholly or partially consolidated with the existing first mortgage;
Scenarios in which different ratios of first mortgage, second mortgage, down payment are developed. An example of the logic by which reasonable different ratios might give rise to varying, potentially advantageous pricing is shown in FIG. 5. One example of the logic by which it is determined which liabilities should receive priority for consideration for consolidation is shown in FIG. 6. The logic of FIGS. 5 and 6 can be implemented in software in the application layer 20 of FIG. 1.
Scenarios in which a down payment is made from cash, by selling investment assets, potentially giving rise to capital gains taxes, and by borrowing against assets to fund the down payment (via vehicles such as a margin loan or a so-called pledged asset mortgage);
Scenarios in which existing consumer loans (e.g. education loans, auto/RV/boat loans, credit cards balances) are refinanced with new, lower priced similar products (e.g. transferring credit card balances to a card with lower interest rates).
Scenarios in which an upfront fee (commonly referred to as “points”) is paid in exchange for a lower interest rate;
Scenarios in which an above-par interest rate is paid in exchange for the lender wholly or partially covering closing costs.

The invention can encompass the use of two methods for selecting and evaluating the lending products to construct potential new scenarios:
A so-called “captive” model under which the list of products to be used are sourced from a single entity (or series of related entities)—the pricing and features of each product are used for generation and evaluation of potential scenarios; and
A so-called “open” model under which the whole range of products available from multiple, unrelated lenders are available to the client and the financial professional and scenarios are built and evaluated and the best pricing for similar products from multiple lenders can be evaluated.

FIG. 5 is a flow chart depicting logic for generating potential liability scenarios depending on the value of a property and the proposed level of debt in relation to the property's value. After starting at step 500, the logic considers whether the total debt is less than a threshold amount at step 502. The threshold amount (TA) can depend on a number of factors, including the number of units for the home. For example, if the unit is a single unit home, the threshold amount could be $417,000, and if the unit is a two-unit home, the threshold amount could be $513,000. If the total debt is not less than the threshold amount at step 502, the logic proceeds to step 504, where it determines whether the primary mortgage (PM) debt is less than the threshold amount. If the primary mortgage debt is less than the threshold amount, the logic proceeds to step 506, where consolidation for the primary mortgage is performed until the threshold amount is met and a possible secondary equity (SE) or mortgage is considered. The decision regarding which liabilities should be consolidated in the primary mortgage and which should be in a secondary equity can be decided using a ranking mechanism for the debts. One such ranking mechanism is described in detail in connection with FIG. 6.

If the result of step 502 is that the total debt is less than the threshold amount, or if the result at step 504 is that the primary mortgage debt is not less than the threshold amount, or after step 506, the logic proceeds to step 508. At step 508, a determination is made as to whether the total debt is less than 80% of the property value (PV). If it is, a step of consolidation into the primary mortgage is performed at step 510 and the logic is completed. If the total debt is not less than 80% of the property value, the logic proceeds to step 512. At step 512, a determination is made as whether the total debt is less than 100% of the property value. If it is, the logic proceeds to step 514, where scenarios are generated for which all debts are consolidated in which the proportion of debt consolidated into the primary mortgage increases at 5% intervals until a scenario is generated in which 100% of the total debt is consolidated into the primary mortgage. In such scenarios, the remainder of the total loan amount is allocated to a potential second-lien mortgage or home equity loan/line of credit. If the total debt is not less than 100% of the property value, the logic proceeds to step 516. At step 516, scenarios are generated in which debt up to but not beyond the property value is consolidated and in which the proportion of debt consolidated into the primary mortgage increases at 5% intervals until a scenario is generated in which 100% of the consolidated debt (equal to the property value) is consolidated into the primary mortgage. In such scenarios, the remainder of the total loan amount is allocated to a potential second-lien mortgage or home equity loan/line of credit. The logic is complete at step 518.

FIG. 6 is a flow chart depicting the logic for choosing which other liabilities in an existing liability portfolio should be prioritized for consideration for consolidation. This ranking mechanism can be used to select which liabilities in a portfolio should be prioritized for consolidation. In general, higher interest rates and higher monthly payments lead to a higher priority, although the weight of these two factors depends on the client's goals. If there is a tie between liabilities, a revolving loan can be consolidated over a fixed loan.

The logic starts at step 600 and 602. At step 604, two liabilities, L1 and L2, that have not already been compared are chosen. At step 606, the goal of the client is determined. If the client's goal is long-term wealth, the logic proceeds to step 610, where the annual interest amounts of L1 and L2 are stored in variables value 1 and value 2 respectively. If, on the other hand, the client's goal is not long-term wealth, the logic proceeds to step 608. At step 608, the monthly payments of L1 and L2 are stored in variables value 1 and value 2 respectively. After step 608 or step 610, the logic proceeds to step 612. At step 612, values 1 and 2 are compared. If value 1 is greater than value 2, liability L1 has a higher ranking than does liability L2 (step 614) and the comparison between the two liabilities is complete (steps 642 and 644). If value 2 is greater than value 1 as determined at step 616, liability L2 has a higher ranking than liability L1 (step 618) and the comparison between the two liabilities is complete (steps 642 and 644).

If, at step 616, value 2 is not greater than value 1, the two values are the same. In this case, the logic proceeds to step 620. At step 620, a determination is made as to whether the client's goal is long-term wealth. If the client's goal is long-term wealth, the logic proceeds to step 624, where the monthly payments of L1 and L2 are set into values 3 and 4 respectively. If the client's goal is not long-term wealth, the logic proceeds to step 622, where the annual interest amount of L1 and L2 is set into values 3 and 4 respectively.

At step 626, a determination is made as to whether value 3 is greater than value 4. If it is, liability L1 has a higher ranking than liability L2 (step 628) and the comparison between the two liabilities is complete (steps 642 and 644). If, at step 630, value 4 is greater than value 3, liability L2 has a higher ranking than liability L1 (step 632) and the comparison between the two liabilities is complete (steps 642 and 644). If values 3 and 4 are the same, the logic proceeds to step 634, where the amount of revolving liabilities for liabilities L1 and L2 are set into values 5 and 6 respectively. If value 5 is greater than value 6 (step 636), liability L1 has a higher ranking than liability L2 (step 640) and the comparison between the two liabilities is complete (steps 642 and 644). If value 5 is not greater than value 6, liability L2 has a higher ranking than liability L1 (step 640) and the comparison between the two liabilities is complete (steps 642 and 644).

The output from step 401 to step 402 in FIG. 4 is a set of scenarios along with some borrower information.

### Step 402 of FIG. 4: Quotation Engine

Step 402 of FIG. 4 uses a quotation engine to develop the best pricing scenarios for the borrower. The pricing information includes information such as a mortgage rate and adjustments based on credit ratings and points paid, along with other basic information about the mortgage. This step retains a scenario generated in the previous step if the scenario is for a product that is available to the account, if the client meets underwriting guidelines and is therefore eligible for the product, and if the pricing for the product offers a potential benefit for the client. At this stage a large number of potential scenarios, such as perhaps thousands, have been passed to the quotation engine, with each scenario including:
Potential new loans—one or more potential new liabilities, including the proposed dollar amount and loan type (e.g. 5/1 ARM mortgage, new credit card etc.); and
Debt items from the existing portfolio left untouched.

Each scenario is then subjected to an evaluation of eligibility and pricing based on the detailed underwriting/lending guidelines of each lender (see discussion of open vs. captive models above). Scenarios are eliminated from consideration for which the borrower does not qualify from any lender, based on a diverse set of information points and up-to-date lender suitability guidelines, such as:
LTV and CLTV
Credit Rating
$ amount of loan
Property Type (e.g. Single family Home, Duplex, 3 unit, co-op etc.)
Property Usage (e.g. Primary residence, Second Home, Investment Property, Lot loan etc.)
Loan type (refinance, cash out refinance, new purchase etc)
Lender limits on the amount of “cash out” that may be taken from of a property
Conforming/Jumbo
State, region
Documentation (stated income etc) etc.

For the surviving, suitable scenarios, the best pricing is found (considering rate and margin add-ons and points) from all available lenders. In addition, further evaluation of each scenario is performed for feasibility using criteria based on the best pricing. For example, the method can evaluate each loan for the property-related payments-to-income ratio (often referred to as PITI-to-income—Principal, Interest, Taxes and Insurance) and total debt-to-income (DTI) ratio and eliminate scenarios exceeding maximum debt-to-income ratios defined by the lender.

At this point, scenarios have:
Potential new loans—one or more potential new liabilities, including the proposed dollar amount, loan type (e.g. 5/1 ARM mortgage, new credit card etc.), and/or the detailed financial characteristics including length of time for which payment levels are fixed, any caps or floors imposed during the life of the loan on interest rate and payment movements, loan margin, prepayment penalty, and closing costs;
Debt items from the existing portfolio left untouched; and
The best pricing from the captive lender or from all available lenders (depending on the model) carrying the product for which the client is eligible.

### Step 403 of FIG. 4: Scenario Selection

Surviving, priced scenarios are then passed into step 403 of FIG. 4 for detailed financial analysis. This step performs a more detailed evaluation of the remaining scenarios from the previous step, considering in-depth cash flow, savings, and risk analysis, and an optimized risk analysis compared to the expected benefits to the client based on the client's goals, such as financial priorities, time horizon, and risk tolerance. The analysis performed depends on the drill-down into specific client goals (three goals: cash flow, long-term wealth, and optimization are discussed here but others, such as improvement of borrower credit rating, are also within the scope of the invention) and the nature of the surviving scenarios. Where there are debt products with potentially variable payments in a scenario, models of the indexes from which these payments are calculated are built and a consequent distribution of possible payments for each debt product over time can be built using the specific features (fixed period, floating period, payments caps, negative amortization features, interest only periods, margin calls, and investment security-based loans) of the products in each scenario.

Index and Payment Modeling

According to one embodiment, the invention includes deriving payment models for any loan in the current or proposed portfolio from index models, as shown in step 403 of FIG. 4. The payment models represent models of projected future payments on a periodic basis, such as month-to-month payments. These payment models can be built using index models, and the payment models use these models and loan characteristics (i.e., underlying index, index margin, payment caps and other characteristics) of liabilities generated in the previous steps above to generate statistical distributions of projected future payments. In some embodiments, payment models can also be pre-generated according to common scenarios. Models for the future distributions of each mortgage index can be built. The shapes of these distributions, including the values of their means (expected future index values), cannot be inferred directly from the shapes of current yield curves or from futures markets, because the prices of these instruments embody premiums associated with investors' aversion to economic risks. A dynamic term structure model is used that formally allows the extraction of market expectations and “best” and “worst” case paths for mortgage indices from cash and option market prices. Yield curves experience change in their slopes and degree of curvature over time with changing macroeconomic conditions. This invention can employ a multi-factor model of the term structure of interest rates that accommodates the diverse shapes of yields curves experienced in the past. Occasional systematic divergences between the various mortgage indices are accommodated through the introduction of index-specific risks. The models are calibrated using market prices of traded caps and floors; they don't simply rely on the past histories of bond yields alone. Traded option prices are “forward looking” and their inclusion at the calibration stage has been shown to improve out-of-sample forecasting and to lead to more reliable models of financial risk.

Cash Flow

Step 403 of FIG. 4 also involves performing an in-depth financial analysis of the payment models for various scenarios using the borrower's information. This analysis can be performed using a “cash flow” goal, a “long-term wealth” goal, or an “optimization” goal. A “cash flow” goal is appropriate if the borrower has indicated that her paramount goal is minimum debt service payments over a particular time horizon. The borrower and the advisor may have also arrived at a “risk tolerance” that will drive the extent to which potential scenarios are penalized for risk of potential future payment increases. Under a cash flow goal, the cash flows for the borrower's current liability portfolio and the potential proposed scenario are compared along expected and worst case paths of the index, according to the model. The difference between the two across the whole specified time horizon is present valued to the current day. The weight given to the worst-case path of payments over the expected path of payments in each scenario varies by risk tolerance (i.e., a conservative investor puts more weight on the worst case path; an aggressive investor puts more weight on the expected path). Scenarios giving the highest present value of cash flow improvement over the horizon are selected. If the user selects the time horizon zero, only the first month's payments are compared. With a cash flow goal, there is no consideration of the impact on long-term wealth—only cash flow differences over the specified time horizon are considered. Consequently, interest only or other alternative mortgage products are quite likely to be favored.

Long-Term Wealth

Under a “long-term wealth” goal, potential liability portfolios can be analyzed in step 403 of FIG. 4 and ranked according to the expected end-of-period utility of wealth that a client will achieve by holding these portfolios to declared time horizons. In other words, this is a goal of maximizing risk-adjusted wealth of the client at an end of a declared time horizon. This approach to ranking portfolios trades off higher expected wealth against the risk of a liability portfolio as reflected in the “tail” of the associated mortgage index distribution. For a long-term wealth goal, the client has specified a time horizon, a risk tolerance, and a maximum cash flow constraint. A distribution for the client's ending wealth at the horizon is built considering: reinvestment of any cash flow savings and how those savings are invested; the returns on any securities pledged to a margin loan, pledged asset mortgage or similar; the ending property value allowing for appreciation or depreciation; and the balance outstanding on the loan at the time horizon. Risk tolerance drives the function used to evaluate the scenarios—more conservative investors penalize a scenario more heavily for higher risk.

Scenarios are ranked by expected utility of wealth at the time horizon, rejecting any scenarios with monthly debt-service cash flow greater than the specified constraint. The highest scoring scenarios that are significantly different in approach are selected.

Optimization

The in-depth analysis of step 403 of FIG. 4 can include an analysis using an “optimization” goal. An “optimization” goal is a hybrid of the two preceding goals, where scenarios are ranked by cash flow savings over a near-term time horizon, but scenarios are eliminated from consideration if the expected utility of wealth, as discussed above under long-term savings, at a longer-term horizon is negatively impacted. That is, such an optimization technique would evaluate scenarios of existing debt products using borrower information and would include ranking scenarios based on minimum debt service payments over a particular time horizon after eliminating scenarios that do not meet a minimum wealth target of the client at an end of a declared time horizon.

Result:

For each goal, the three (in this example, could be any number) scenarios producing the best expected impact using distinct lending products, appropriately penalized for risk (based on risk tolerance) are selected.

### Step 404 of FIG. 4 (Also Shown as Step 4 of FIG. 1): Proposal Generation

In step 404 of FIG. 4, each recommended scenario is presented to the financial professional as a plan via the Internet. This can be shown to the borrower if she is in the same office, or the advisor can print and mail or email a well-formatted PDF or similar format of one or more of the plans for the various scenarios. The presentation can include displaying charts comparing the scenarios including but not limited to: (1) a comparison of expected cash flows and principal repayment schedules under each scenario and for the existing portfolio, (2) illustrations of the risk in terms of the distribution of future loan payment levels, the distribution of ending wealth in each scenario (potentially including the effects of different levels of funds flowing into the borrower's investment portfolio; the future value of the borrower's real property and investment assets; etc.); and (3) a comparison of the varying impact of making accelerated mortgage payment versus investing more funds in the borrower's investment portfolio. These embodiments of the invention can also allow the borrower, either directly or via the advisor, to complete and transmit an application for new loans to a loan processing system or physical team and a mechanism for monitoring the ongoing status of such an application. In the embodiments set forth above, the status and detailed status descriptions and histories (conversation logs) can be retrieved from the computer systems used to underwrite and originate loans and display those statuses and descriptions to the borrower and the advisor.

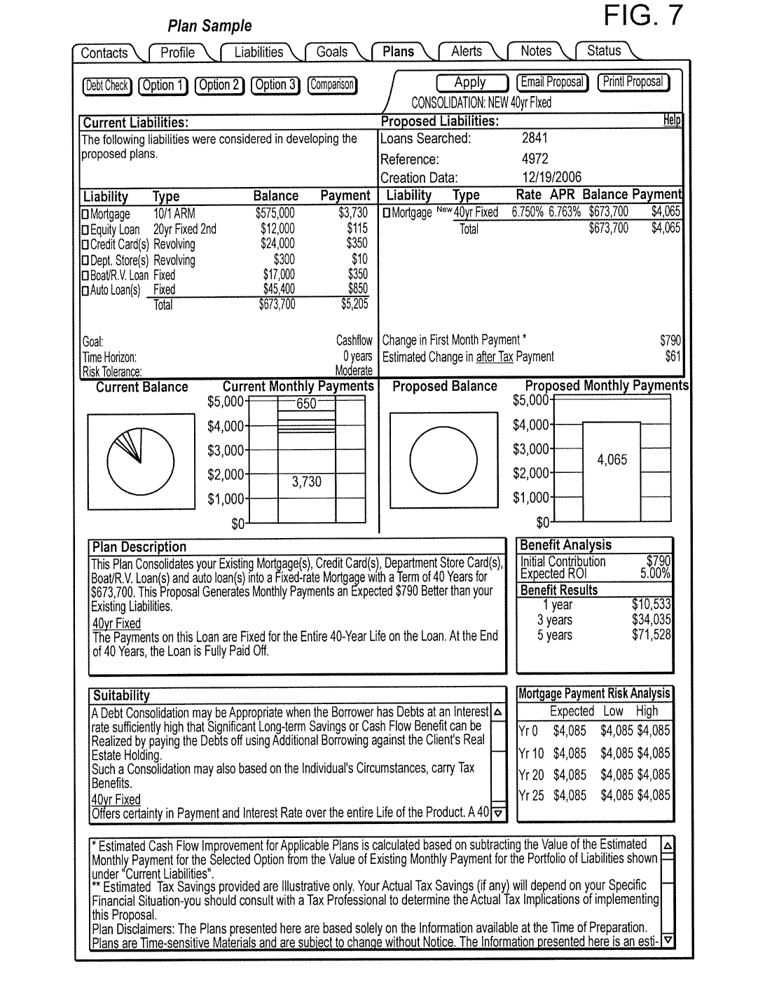

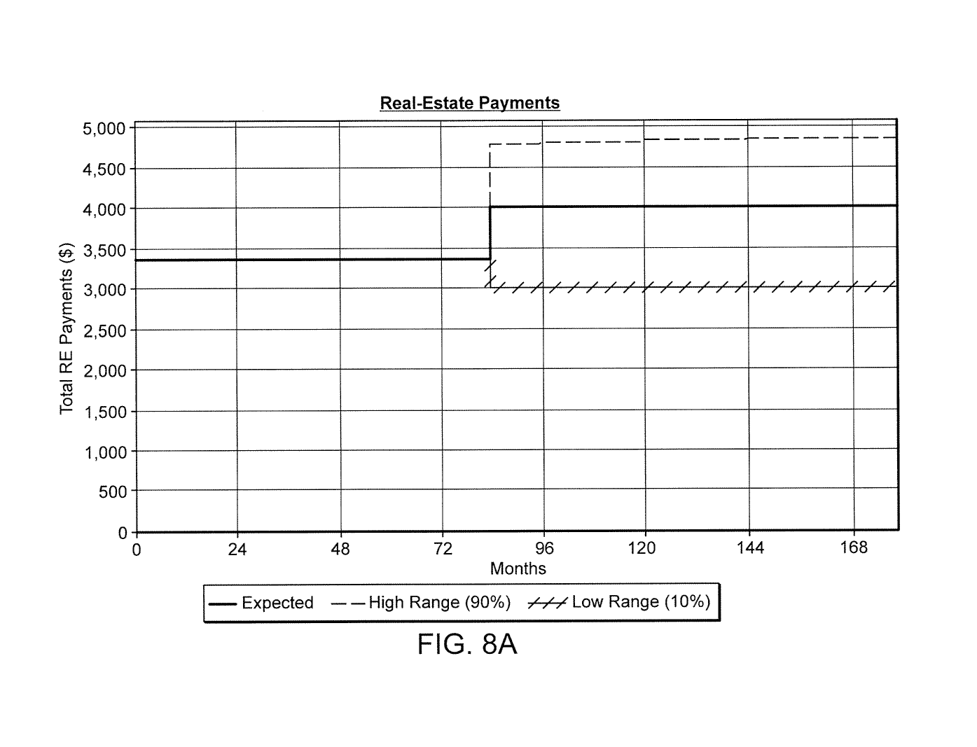

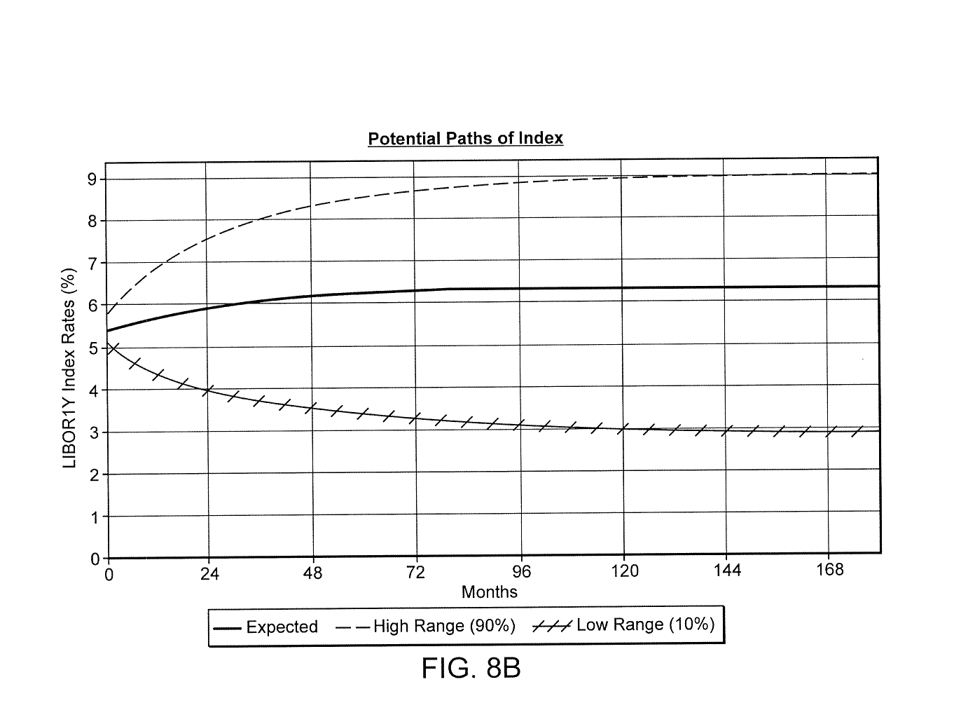

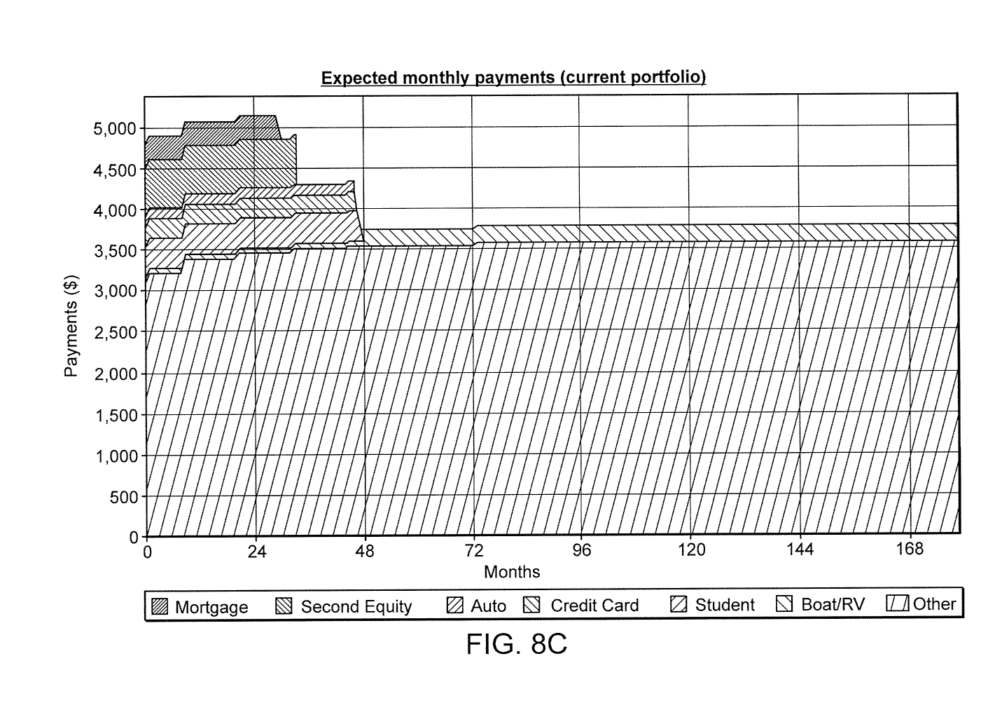

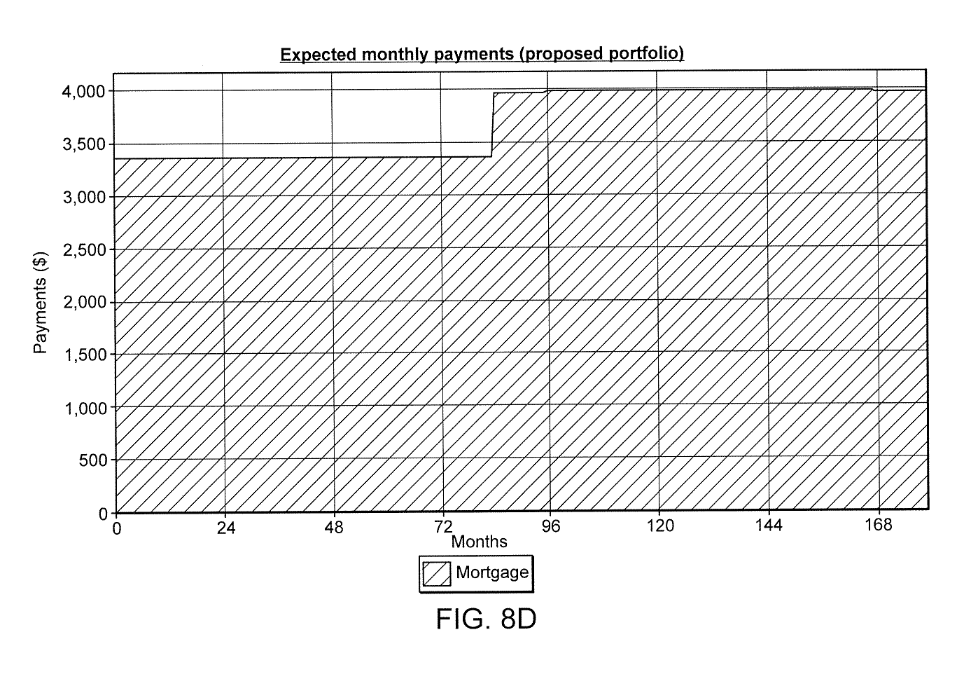

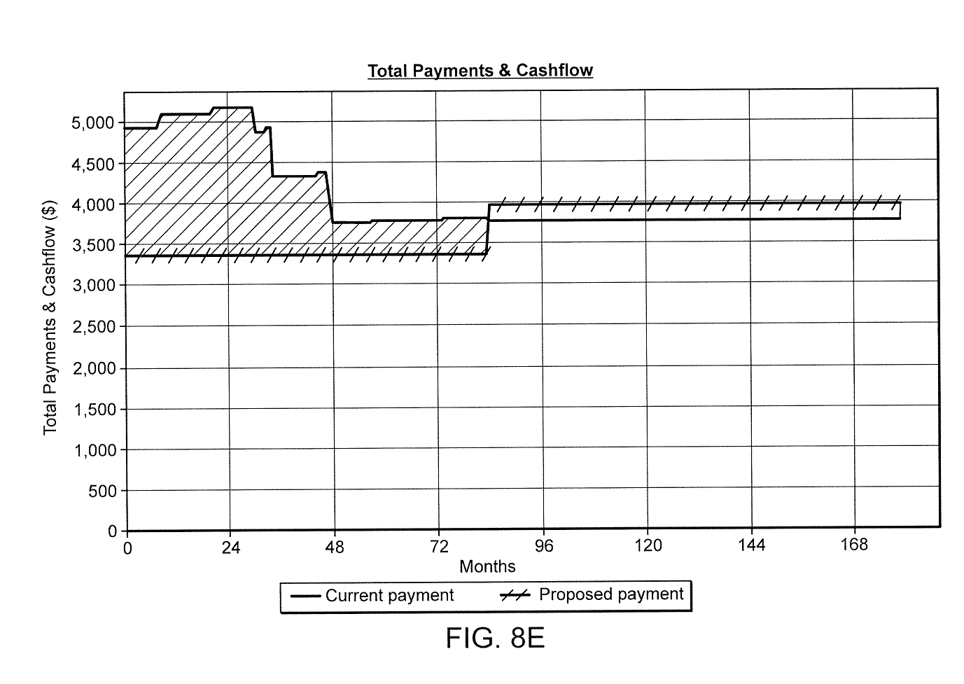

An example report, displaying option one of three options, is shown in FIG. 7. As shown in FIG. 7, the plan may include: a side-by-side comparison of the current liability portfolio and the proposed new portfolio comparing principal amounts and monthly payments; an estimate of the long-term benefit to the client at their stated time horizon if the new plan is executed; an estimate of the difference in tax treatment between the two scenarios; a detailed, customized description of the plan and the new lending products recommended in the plan, dynamically describing both what is being recommended and the specific details of the loans being proposed (including but not limited to: principal amount; starting rate; fixed period; interest only period; floating rate index and margin; initial, subsequent and lifetime caps); a detailed description of the pros and cons of the lending product(s) being recommended; a what-if illustration of the benefits that might accrue were estimated monthly savings to be invested at a rate selected by the client; an estimate of both the expected payments over time and an estimate of the distribution of payments over time—in the example shown “best” and “worst” case paths equivalent to the 90% confidence interval around the expected value are shown; a selection of graphs to illustrate aspects of the existing and proposed portfolios including, but not limited to, a visualization of the distributions of index levels and debt payments, comparisons of expected payments under the existing portfolio and the proposed portfolio, comparisons of the level of outstanding principal over time current versus proposed, an illustration of the potential benefits from reducing debt service payments and investing the savings. Examples of such graphs are shown in FIGS. 8A-8E. The aim is to present a balanced view of the relative risks and benefits of each option when compared to the existing situation. FIG. 8A shows high, low, and expected ranges for real estate payments. FIG. 8B shows high, low, and expected ranges for index rates. FIG. 8C shows expected monthly payments for a variety of types of debt products under a current portfolio. FIG. 8D shows expected monthly payments for a variety of types of debt products under a proposed portfolio. FIG. 8E shows expected payments under a current portfolio and under a proposed portfolio, with the different between the two shaded for effect. As shown, the proposed portfolio results in lower short-term payments and only slightly higher long-term payments than the current portfolio in the depicted example.

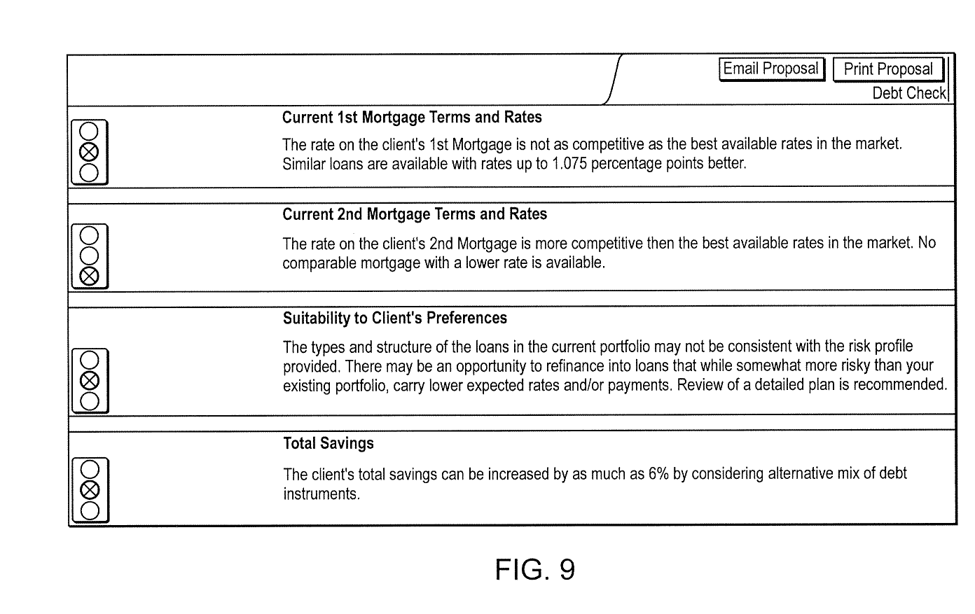

A high level overview of the borrower's current debt situation can also be used to help the borrower understand if there are opportunities to improve the borrower's financial situation via their liabilities. One example of such an overview is shown in FIG. 9. FIG. 9 indicates if there are opportunities to improve the borrower's financial situation based on current first mortgage terms and rates, current second mortgage terms and rates, suitability to the client's preferences, and total savings.

Once a plan has been shared with the client, the financial professional and the borrower may agree that the borrower will go ahead with the new loans/lending products, using the proceeds to fund the borrower's new needs (such as a home purchase) or to consolidate existing debt.

The financial professional can choose to apply for a particular scenario on the borrower's behalf and, in step 108 of FIG. 2, the professional can complete applications for the relevant mortgage products, providing any data not already captured from the client but required for a thorough application for the applicable product(s). The financial professional can then transmit the application to the appropriate loan-processing center for the product and the provider of that product can take the process further.

According to some embodiments of the invention, status updates are transmitted back from the processing center and displayed to the professional as the process progresses.

Once the plan is completely implemented, the financial professional transitions to step 110 of FIG. 2, wherein a client's liability portfolio can be taken automatically through steps 401-404 of FIG. 4 daily and the potential benefit from restructuring the portfolio can be recalculated. As factors affecting liability decisions change—factors such as: interest rates; the value of the client's property; the client's credit rating and liabilities; and the range of products and their eligibility guidelines and pricing, new opportunities to improve on the client's situation can appear—the financial professional is presented with an alert when a sufficiently attractive situation presents itself. In the embodiments described above, updates on a borrower's circumstances can be pulled, in a timely manner, either systematically or manually, into the system—potentially changing the benefit of a new approach to liabilities day-to-day. Such updates can include but are not limited to: (1) the borrower's credit worthiness (measured by FICO score, Vantage score, or other sources); (2) up-to-date lists of the borrower's debt obligations from credit agencies and other sources; (3) up-to-date property value estimates from Automated Valuation Model systems (AVM) and other sources; (4) up-to-date information on the client's asset levels available for investment, asset allocation percentages and individual security quantities; (5) up-to-date information on the cost basis of the client's investments; (6) up-to-date tax regulations at a federal and state level; and (7) updates to the client-provided information.

The method can allow the advisor and borrower to be alerted via a variety of electronic methods in a variety of circumstances including but not limited to a time when the short or long-term benefits of restructuring the borrower's portfolio of liabilities exceeds some pre-determined amount or percentage, and a time when a significant event in the life of some portion of the existing liability portfolio such as, but not limited to: (1) the value of real property is sufficiently above the value of loans against that property that an application to remove Private Mortgage Insurance (PMI) can be made; (2) a fixed interest period of a loan is about to come to an end and rates and payments may therefore change; (3) a loan is about to be “recast” such that payments are expected to rise substantially; and (4) a margin call or other call for additional assets in a loan secured by investment securities is likely.

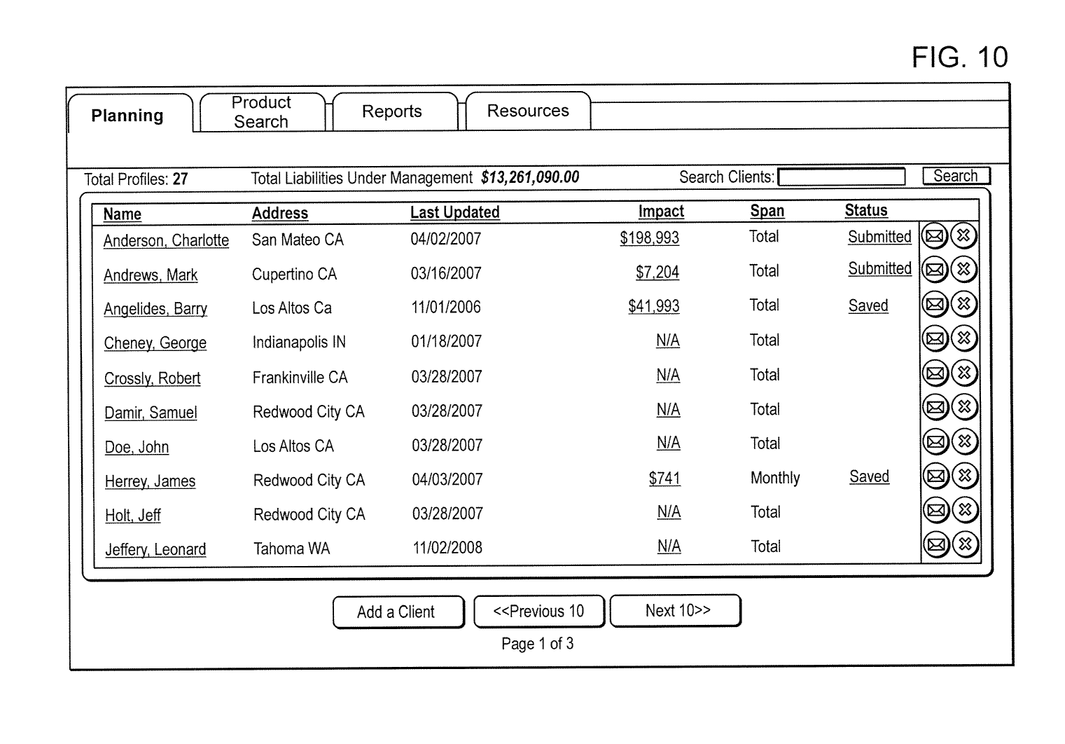

This process of monitoring for situations in which there are further opportunities for a beneficial restructuring of liabilities, based on changing factors can, according to an embodiment of the invention, be repeated daily for all of a financial professional's clients—or indeed for all the clients of a financial institution. FIG. 10 shows an example of the so-called “prospecting” page used to display these opportunities to the professional. The “N/A” in the impact column of FIG. 10 indicates a client for whom there is no beneficial opportunity to restructure currently.

Updated property values, lists of liabilities, and credit scores can either be updated manually in discussion with the client over time or can be automatically downloaded from third-party providers of automated property valuation and consumer credit-related data.

In accordance with the foregoing, the present invention provides an online system and process that permits a financial professional or institution to offer a borrower a choice of lending products of all forms from a menu available from one or more lenders that best match the borrower's needs, constraints and goals. The inventive system and process enable a financial professional to assist a borrower in making this choice and also enable the borrower to make this choice for himself.

Some embodiments of the invention described herein can be implemented, at least in part, using software-controlled programmable processing devices, such as a computer system. One or more computer programs for configuring such programmable devices or systems of devices to implement the foregoing described methods are to be considered an aspect of the present invention. The computer programs can be embodied as source code and undergo compilation for implementation on processing devices or a system of devices, or can be embodied as object code. Those of ordinary skill in the art will readily understand that the term computer in its most general sense encompasses programmable devices such as those referred to above, and data processing apparatus, computer systems and the like.

In some embodiments, the computer programs are stored on carrier media in machine or device readable form, for example in solid-state memory or magnetic memory such as disk or tape, and processing devices utilize the programs or parts thereof to configure themselves for operation. The computer programs can be supplied from remote sources embodied in communications media, such as electronic signals, radio-frequency carrier waves, optical carrier waves and the like. Such carrier media are also contemplated as aspects of the present invention.

It will thus be seen that the objects set forth above, among those made apparent from the preceding description, are efficiently attained and, since certain changes can be made in carrying out the above method and in the constructions set forth for the system without departing from the spirit and scope of the invention, it is envisioned that all matter contained in the above description and shown in the accompanying drawings shall be interpreted as illustrative and not in a limiting sense. Accordingly, the invention should not be limited by the description above, but instead only by the following claims.

What is claimed is:

1. A computerized method for providing a borrower with a choice of products relating to new debts or changes to a portfolio of debts, the method comprising:
a) collecting borrower information using a user interface;
b) building scenarios of debt products currently available to the borrower;
c) evaluating the scenarios of debt products using (i) payment models for the scenarios determined based on interest and loan information and (ii) the borrower information; and
d) selecting one or more of the scenarios based on the evaluation of the scenarios.

2. The method of claim 1, further comprising presenting the one or more scenarios to a user via a computer system.

3. The method of claim 1, wherein building scenarios of debt products includes using borrower information and determinations of borrower eligibility and pricing information for the debt products.

4. The method of claim 1, wherein building scenarios includes considering a list of products from one or more related entities.

5. The method of claim 1, wherein building scenarios includes considering a list of products from multiple, unrelated lenders.

6. The method of claim 1, wherein building scenarios includes retaining scenarios of debt products having the best pricing for the borrower.

7. The method of claim 1, further comprising generating an application for one of the debt products using the collected borrower information.

8. The method of claim 1, wherein the payment models are based on statistical models for mortgage indices.

9. The method of claim 8, wherein the payment models are based on market prices.

10. The method of claim 1, wherein evaluating the scenarios of debt products using borrower information includes consideration of a goal of minimum debt service payments over a particular time horizon.

11. The method of claim 1, wherein evaluating the scenarios of debt products using borrower information includes consideration of a goal of maximizing wealth of the client at an end of a declared time horizon.

12. The method of claim 1, wherein evaluating the scenarios of debt products using borrower information includes ranking scenarios based on minimum debt service payments over a particular time horizon after eliminating scenarios that do not meet a minimum wealth target of the client at an end of a declared time horizon.

13. The method of claim 1, further comprising presenting a high level overview of a current debt situation of the borrower to illustrate opportunities to improve the borrower's financial situation.

14. The method of claim 1, further comprising evaluating a current liability portfolio of the borrower to identify opportunities for improvement and risks if no action is taken.

15. A computerized method for providing a borrower with a choice of products relating to new debts or changes to a portfolio of debts, the method comprising:
a) collecting borrower information using a user interface;
b) generating possible scenarios of debt products for the borrower;
c) retaining scenarios of debt products currently available to the borrower based on the borrower information and determinations of borrower eligibility and pricing information for the debt products;
d) building payment models for the scenarios using models based on interest and loan information;
e) evaluating the payment models using the borrower information; and
f) selecting one or more of the scenarios based on the evaluation of payment models.

16. The method of claim 15, further comprising presenting the one or more scenarios to a user via a computer system.

17. The method of claim 15, wherein evaluating the payment models using the borrower information includes consideration of a goal of minimum debt service payments over a particular time horizon.

18. The method of claim 15, wherein evaluating the payment models using the borrower information includes consideration of a goal of maximizing risk-adjusted wealth of the client at an end of a declared time horizon.

19. An apparatus for providing a borrower with a choice of products relating to new debts or changes to a portfolio of debts, the apparatus comprising:
a) a user interface module to collect borrower information;
b) a scenario generation module to generate possible scenarios of debt products for the borrower;
c) a quotation engine to retain scenarios of debt products currently available to the borrower based on the borrower information and determinations of borrower eligibility and pricing information for the debt products; and
d) a scenario selection module to
i) build payment models for the scenarios using models based on interest and loan information;
ii) evaluate the payment models using the borrower information; and
iii) select one or more of the scenarios based on the evaluation of payment models.

20. The apparatus of claim 19, further comprising a module to monitor a portfolio on a periodic basis and identify circumstances in which changes in the liability portfolio are warranted.

21. The apparatus of claim 19, further comprising a transaction management module to generate an application for one of the debt products using the collected borrower information.

22. The apparatus of claim 19, wherein the user interface module presents the one or more scenarios to a user via a computer system.

23. The apparatus of claim 22, wherein the presented scenarios include a discussion of suitability and relative risks and benefits to the borrower.
